(19) United States
(12) Patent Application Publication
(10) Pub. No.: US 2026/0270021 A1
(43) Pub. Date: Sep. 10, 2026

(54) SYSTEMS AND METHODS FOR HYBRID AUTOMATIC REPEAT REQUEST FEEDBACK ENABLEMENT/DISABLEMENT

(71) Applicant: APPLE INC., Cupertino, CA (US)

(72) Inventors: Chunxuan Ye, San Diego, CA (US); Dawei Zhang, Saratoga, CA (US); Wei Zeng, San Diego, CA (US); Hong He, San Jose, CA (US); Jie Cui, San Jose, CA (US); Chunhai Yao, Beijing (CN); Haitong Sun, Cupertino, CA (US)

(21) Appl. No.: 19/166,649

(22) PCT Filed: Apr. 6, 2023
(86) PCT No.: PCT/CN2023/086463

§ 371 Date: Sep. 18, 2025

(51) Int. Cl. H04L 5/00

(52) U.S. Cl. CPC H04L 5/0055; H04L 5/0044

(57) ABSTRACT

Systems and methods for hybrid automatic repeat request (HARQ) feedback enablement/disablement are discussed herein. A user equipment (UE) may receive, from a network, configuration information comprising an indication for the UE to use HARQ enablement information of a downlink control information (DCI), receive the DCI comprising the HARQ enablement information, and use the HARQ enablement information of the DCI to determine one or more HARQ enablement statuses for corresponding one or more HARQ processes for communicating HARQ acknowledgement (HARQ-ACK) information from the UE to the network or for one or more TBs using such HARQ processes. A network device may send configuration information to the UE comprising an indication for the UE to use HARQ enablement information of a DCI and send the UE the DCI comprising the HARQ enablement information. Applicable contexts for methods disclosed herein may include, for example, Internet of Things (IoT) and/or non-terrestrial network (NTN) contexts.

### TECHNICAL FIELD

This application relates generally to wireless communication systems, including wireless communication systems implementing Internet of Things (IoT) non-terrestrial networks (NTNs).

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR 2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a method of a UE, according to embodiments herein.

FIG. 2 illustrates a method of a RAN, according to embodiments herein.

FIG. 3 illustrates a method of a UE, according to embodiments herein.

FIG. 4 illustrates a method of a RAN, according to embodiments herein.

FIG. 5 illustrates an NTN architecture of a wireless communication system, according to an embodiment.

FIG. 6 illustrates an NTN architecture of a wireless communication system, according to an embodiment.

FIG. 7 illustrates an example architecture of a wireless communication system, according to embodiments disclosed herein.

FIG. 8 illustrates a system for performing signaling between a wireless device and a RAN device connected to a core network of a CN device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Hybrid automatic repeat request (HARQ) feedback as implemented by a UE may include sending, to the network, one or more hybrid automatic repeat request (HARQ) acknowledgment (ACK) (HARQ-ACK) transmissions having HARQ-ACK information that inform the network whether or not the UE successfully received expected (e.g., scheduled) downlink (DL) signaling from the network. The network is thus enabled to adjust further scheduling/communication with the UE accordingly (e.g., may schedule/send a retransmission of DL signaling in the case that a first transmission of the DL signaling was not successfully received at the UE).

It may be beneficial to improve/enhance the performance of wireless communication networks operating in Internet of Things (IoT) non-terrestrial network (NTN) operation contexts. One IoT NTN performance enhancement objective may be to support mechanisms for the disabling of hybrid automatic repeat request (HARQ) feedback in order to mitigate impact of HARQ stalling on user equipment (UE) data rates (e.g., due to communication latency over the NTN link).

In some cases, it may be that some components of HARQ feedback disabling are determined as follows. For narrow band Internet of Things (NB-IoT) NTN operation and enhanced machine type communication (eMTC) NTN operation for coverage enhancement (CE) Mode B, various options for configuring/indicating and enabling/disabling of HARQ feedback for a DL transmission may exist.

For example, under a first case (“Option 1”), a per-HARQ process bitmap may be configured to the UE semi-statically (e.g., via radio resource control (RRC) signaling), where the bit(s) of the bitmap indicate whether corresponding HARQ process(es) are enabled or disabled.

In another case (“Option 3”) (note that an “Option 2” is not referred to herein), a direct indication of HARQ feedback that is enabled/disabled may be made in downlink control information (DCI). In such cases, the indication of HARQ feedback is provided and used instead of a semi-static per-HARQ process bitmap at the UE.

As another example, in another case (“Option 3”+“Option 1”), a DCI indication of HARQ feedback (as in “Option 3”) is used to override a semi-statically configured per-HARQ process bitmap also configured at the UE (as in “Option 1”). Such a DCI-based HARQ configuration override mechanism may be used to override the configuration of the UE by the semi-statically configured per-HARQ process bitmap either in whole or in part.

In such DCI-based HARQ configuration override mechanism cases, there may be various aspects to be considered. A first aspect for consideration is whether the DCI-based HARQ configuration override mechanism may be used/applied with respect to both semi-statically enabled HARQ feedback processes and semi-statically disabled HARQ feedback processes, or whether any HARQ enablement information in the DCI (e.g., DCI-provided override information) is only used/applied with respect to one of (but not the other of) semi-statically HARQ feedback disabled processes and semi-statically enabled HARQ feedback processes. Further, a second aspect to be considered relates to whether and/or how to support a DCI-based HARQ configuration override mechanism for the case where there are multiple transport blocks (TBs) scheduled by single DCI. Finally, a third aspect to be considered relates to whether a DCI-based HARQ configuration override mechanism applies signaling in the DCI to reverse all or part of a per-HARQ process semi-static configuration with respect to potential corresponding HARQ-ACK transmissions having related HARQ-ACK information, or whether the signaling in the DCI is interpreted instead as directly indicating the enablement status for all or part of the potential HARQ-ACK transmissions corresponding to the per-HARQ process RRC configuration (regardless of the state of the per-HARQ process RRC configuration).

It may be beneficial to use a common design (e.g., in terms of DCI design, physical downlink control channel (PDCCH) monitoring design, etc.) for “Option 3” and “Option 3+Option 1” cases.

Further, note that for eMTC NTN, a mechanism used to configure/indicate enablement status(es) of HARQ feedback for DL transmission(s), “Option 1” as described herein may be used in CE Mode A.

With respect to the preceding discussion, various scenarios may be considered. For example, for a DCI-based HARQ configuration override mechanism in the case of a single TB that is scheduled by DCI, one of the following alternatives may be selected. In a first alternative, the DCI-based HARQ configuration override mechanism is applied with respect to both semi-statically enabled HARQ processes and semi-statically disabled HARQ processes. In a second alternative, the DCI-based HARQ configuration override mechanism is applied with respect to only semi-statically disabled HARQ processes. In a third alternative, the DCI-based HARQ configuration override mechanism is applied with respect to only semi-statically enabled HARQ processes. The selection between these alternatives may be based on applicable criteria, such as DCI overhead, PDCCH monitoring/power consumption, HARQ timer operation, impacts on scheduling flexibility, UE implementation complexity considerations, etc.

Further, various scenarios for DCI design are also applicable. In cases where a DCI-based HARQ configuration override mechanism is used to provide HARQ enablement information in the DCI, or where semi-static HARQ process configuration is not provided (and the HARQ enablement information of the DCI is thus interpreted as a direct indication of enablement status for all or some of the applicable HARQ transmissions), various alternatives may be considered for the field of the DCI that is used. In a first alternative, the HARQ enablement information may be carried in a field of DCI that is in addition to fields currently understood to be in use according to definitions for applicable wireless communication systems (e.g., a new field in DCI may be specified for use in a specification for an NR wireless communication system). In a second alternative, the HARQ enablement information may be carried in a field of DCI that is already understood to be in use according to definitions for applicable wireless communication systems, but which has been repurposed. The selection between these alternatives may be based on applicable criteria, such as DCI overhead, PDCCH monitoring behavior, impacts on scheduling flexibility, UE implementation complexity considerations, etc.

Finally, when considering the manner of supporting the disabling or modifying of HARQ feedback in IoT NTN, in a case where a DCI indication is used to override semi-static HARQ configuration information for corresponding HARQ transmissions, it may be that the use of a DCI-based HARQ configuration override mechanism is applicable to both semi-statically enabled HARQ processes and semi-statically disabled HARQ processes, or is only used/applied with respect to one of (but not the other of) semi-statically enabled HARQ processes and semi-statically disabled HARQ processes. Further, in some embodiments, it may be that HARQ enablement information in DCI is interpreted as potentially reversing all or part of a semi-static HARQ processes configuration with respect to one or more HARQ-ACK transmissions, while in other cases it may be that HARQ enablement information in DCI is interpreted instead as directly indicating the enablement status for all or part of the potential HARQ-ACK transmissions corresponding to the semi-static HARQ process configuration.

### Configurations With Respect to DCI-based HARQ Configuration Override Mechanisms

With respect to embodiments of wireless communications systems that can use DCI-based HARQ configuration override mechanisms, it may be that RRC configuration information is (e.g., semi-statically) provided to the UE by the network as follows.

The RRC configuration information may include a per-HARQ process bitmap that indicates a semi-static configuration for HARQ enablement status(es) for one or more HARQ processes (where a HARQ enablement status for a HARQ process denotes whether that HARQ process is enabled or disabled). For example, a “0” bit may indicate that a HARQ process corresponding to the bit has an HARQ enablement status of enabled, while a “1” bit may indicate that a HARQ process corresponding to the bit has a HARQ enablement status of disabled. It is contemplated that the indications provided by the bit values may be reversed from this example in some wireless communication systems.

Note that in at least some applicable cases discussed herein, a per-HARQ process bitmap may not be provided to the UE. In such cases, any HARQ enablement information of a DCI may be interpreted as a direct indication of enablement status for all or some of the HARQ transmissions in question.

The RRC configuration information may also include an indication regarding the use of HARQ enablement information of a DCI. In some cases, it may be that an indication regarding the use of the HARQ enablement information indicates that the UE uses HARQ enablement information of a DCI to determine one or more HARQ enablement statuses for one or more corresponding HARQ processes. In other cases, it may be that the indication indicates that the UE does not use HARQ enablement information of a DCI (if any).

In a first alternative, it may be that the indication comprises a single bit that indicates whether or not the UE is to use HARQ enablement information of a DCI.

Under this alternative, it may be that if the indication provides a value of “0,” HARQ enablement information of a DCI is not applied at the UE, while if on the other hand the indication provides a value of “1,” HARQ enablement information of a DCI is applied at the UE. It is contemplated that the indications provided by the bit values may be reversed from this example in some wireless communication systems.

In a second alternative, it may be that the indication is more complex than that presented in the first alternative. In some cases according to the second alternative, the indication regarding the use of the HARQ enablement information comprises two bits. Under such cases, it may be that if the indication provides a value of “00,” HARQ enablement information of a DCI is not applied at the UE. Further, it may be that if the indication provides a value of “01,” HARQ enablement information of a DCI is applied with respect to both semi-statically enabled HARQ processes and semi-statically disabled HARQ processes. Still further, it may be that if the indication provides a value of “10,” HARQ enablement information of a DCI is applied with respect to only semi-statically disabled HARQ processes. Still further, it may be that if the indication provides a value of “11,” HARQ enablement information of a DCI is applied with respect to only semi-statically enabled HARQ processes. Note that the particular mapping between particular bit values for the indication and the associated treatment of HARQ enablement information may be differently arranged from this example in some wireless communication systems.

Other alternatives may contemplate the ability to configure a subset of all possible treatments for HARQ enablement information of a DCI. For example, in a third alternative, it may be that the indication comprises a single bit. Under this alternative, if the indication provides a value of “0,” HARQ enablement information of a DCI is applied with respect to both semi-statically enabled HARQ processes and semi-statically disabled HARQ processes. Further, if the indication provides a value of “1,” HARQ enablement information of a DCI is applied with respect to only semi-statically disabled HARQ processes.

Further, in a fourth alternative, it may be that the indication comprises a single bit. Under this alternative, if the indication provides a value of “0,” HARQ enablement information of a DCI is applied with respect to only semi-statically disabled HARQ processes. Further, if the indication provides a value of “1,” HARQ enablement information of a DCI is applied with respect to only semi-statically enabled HARQ processes.

Note that the third and fourth alternative are given by way of example, and not by way of limitation. In other cases, other (e.g., 1-bit) values of the indication could be mapped to different associated treatments for HARQ enablement information.

Note generally that in cases where there is no indication regarding the use of HARQ enablement information of a DCI, the HARQ process information of the DCI (if any) may not be used.

### HARQ Process Information Interpretation in View of Configuration Information

Some possible embodiments for the interpretation of HARQ process information received in a DCI in view of the active configuration information (e.g., as discussed herein) are now provided. Note that these examples are given by way of example and not by way of limitation.

First examples relate to a case where RRC configuration information includes an indication regarding the use of HARQ enablement information (e.g., of a single bit) that indicates whether or not to use HARQ enablement information of a DCI.

In such a case, if a per-HARQ process bitmap is not configured by RRC, and if an indication regarding the use of HARQ enablement information of a DCI in RRC indicates that the HARQ enablement information of a DCI is not applied at the UE, the UE may consider that the applicable HARQ enablement status for all HARQ processes is an enabled status. Note that this may also be the result if a per-HARQ process bitmap is not configured by RRC and no indication regarding the use of HARQ enablement information of a DCI is provided in RRC.

Further, if a per-HARQ process bitmap is configured by RRC, and if an indication regarding the use of HARQ enablement information of a DCI in RRC indicates that the HARQ enablement information of a DCI is not applied at the UE, the UE may determine HARQ enablement statuses for the HARQ process(es) according to the per-HARQ process bitmap. Note that this may also be the result if a per-HARQ process bitmap is configured by RRC and if no indication regarding the use of HARQ enablement information of a DCI is provided in RRC.

Further, if a per-HARQ process bitmap is not configured by RRC, and if an indication regarding the use of HARQ enablement information of a DCI in RRC indicates that the HARQ enablement information of a DCI is applied at the UE, any HARQ enablement information of the DCI may be directly applied to determine HARQ enablement statuses for the HARQ process(es).

Finally, if a per-HARQ process bitmap is configured by RRC, and if an indication regarding the use of HARQ enablement information of a DCI in RRC indicates that the HARQ enablement information of a DCI is applied at the UE, a DCI-based HARQ configuration override mechanism (e.g., as discussed herein) is applied. In such cases, the HARQ enablement information of a DCI that is used may be provided via, for example, the use of an additional field of such a DCI or through the reuse/reinterpretation of an existing field in DCI (e.g., in the manner that is discussed herein).

Second examples relate to a case where RRC configuration information includes an indication regarding the use of HARQ enablement information that is more complex than that contemplated by the first example (e.g., in the manner discussed herein that uses two bits, making possible a more granular set of possible indications).

In such a case, if a per-HARQ process bitmap is not configured by RRC, and if HARQ enablement information of a DCI is not configured to be applied at the UE, then the UE may treat all HARQ process(es) as enabled. Note that this may also be the result if a per-HARQ process bitmap is not configured by RRC and no indication regarding the use of HARQ enablement information of a DCI is provided in RRC.

Further, if a per-HARQ process bitmap is not configured by RRC, and if HARQ enablement information of a DCI is configured to be applied with respect to both semi-statically enabled HARQ processes and semi-statically disabled HARQ processes, any HARQ enablement information of the DCI may be directly applied to determine HARQ enablement statuses for the HARQ process(es). In such cases, the HARQ enablement information of a DCI that is used may be provided via, for example, the use of an additional field of such a DCI (e.g., in the manner that is discussed herein).

Further still, if a per-HARQ process bitmap is configured by RRC, and if HARQ enablement information of a DCI is not configured to be applied at the UE, then the UE may simply use HARQ processes as configured by the per-HARQ process bitmap. Note that this may also be the result if a per-HARQ process bitmap is configured by RRC and no indication regarding the use of HARQ enablement information of a DCI is provided in RRC.

Further still, if a per-HARQ process bitmap is configured by RRC, and if HARQ enablement information of a DCI is configured to be applied with respect to both semi statically enabled HARQ processes and semi-statically disabled HARQ processes, a DCI-based HARQ configuration override mechanism is applied with respect to both semi-statically enabled HARQ and semi-statically disabled HARQ processes. In some such cases, the HARQ enablement information of a DCI that is used may be provided via, for example, the use of an additional field of such a DCI (e.g., in the manner that is discussed herein). Note that in first sub-cases, this field may be interpreted as having direct indication(s) of HARQ enablement status(es) of the HARQ process(es), regardless of any semi-static HARQ process configuration. In second sub-cases, this field may instead be interpreted to potentially reverse one or more enablement status(es) of one or more HARQ processes as indicated in a per-HARQ process bitmap (e.g., in the manner discussed herein).

Further still, if a per-HARQ process bitmap is configured by RRC, and if HARQ enablement information of a DCI is configured to be applied with respect to only semi-statically disabled HARQ processes, then a DCI-based HARQ configuration override mechanism is applied with respect to semi-statically HARQ disabled processes. In some such cases, the HARQ enablement information of a DCI that is used may be provided via the reuse/reinterpretation of a field of an existing field of such a DCI (e.g., in the manner that is discussed herein). Note that in some such cases this field may be interpreted to potentially reverse one or more indications in a per-HARQ process bitmap that one or more HARQ process(es) are disabled (e.g., in the manner discussed herein).

Further still, if a per-HARQ process bitmap is configured by RRC, and if HARQ enablement information of a DCI is configured to be applied with respect to only semi-statically enabled HARQ processes, then a DCI-based HARQ configuration override mechanism is applied with respect to semi-statically HARQ enabled processes. In some such cases, the HARQ enablement information of a DCI that is used may be provided via the reuse/reinterpretation of a field of an existing field of such a DCI (e.g., in the manner that is discussed herein). Note that in some such cases this field may be interpreted to potentially reverse one or more indications in a per-HARQ process bitmap that one or more HARQ process(es) are enabled (e.g., in the manner discussed herein).

### Embodiments With Respect to Using a Single DCI That Schedules Multiple TBs

In some implementations of some wireless communication systems, it may be that a single DCI is used to schedule multiple DL TBs for the UE. Each of the TBs may each use/be associated with one of one or more HARQ processes at the UE for communicating HARQ-ACK information corresponding to the TB (e.g., regarding the receipt of the TB) to the network. It is contemplated that such implementations may be capable of using HARQ enablement information of a DCI. In in at least some such cases, the use of the HARQ enablement information may be applied at the TB granularity level, as will be described.

In some such implementations, if a per-HARQ process bitmap is configured by RRC, and if HARQ enablement information of a DCI (e.g., that schedules the TBs) is not configured to be applied at the UE, the system may effectively assume that all the scheduled TBs have ACK/negative acknowledgment (NACK) feedback. In such cases, it may be that an ACK is assumed by the network and/or in any case reported by the UE for any semi-statically disabled HARQ processes, while a substantive ACK/NACK (selected according to actual receipt circumstances) may be used between the UE and the network for any semi-statically enabled HARQ processes.

Further, if a per-HARQ process bitmap is not configured by RRC, and if HARQ enablement information of a DCI (e.g., that schedules the TBs) is configured to be applied with respect to both semi-statically enabled HARQ processes and semi-statically disabled HARQ processes, various alternatives are possible. In a first alternative, it may be that a single value (e.g., a single bit) in a field of the DCI indicates HARQ enablement statuses for all the TBs, where a HARQ enablement status for a TB denotes whether that TB is enabled or disabled from using its corresponding HARQ process. In other words, a HARQ enablement status for each TB will be set in the manner represented by the single value. In a second alternative, it may be that multiple values (e.g., multiple bits) in a field of the DCI each indicate a HARQ enablement status for a corresponding one of the TBs. In such cases, an upper bound on the bit fields is assumed in the DCI.

Still further, if a per-HARQ process bitmap is not configured by RRC, and if HARQ enablement information of a DCI (e.g., that schedules the TBs) is configured to be used, various cases may exist. Note that examples of these various cases that are now provided are given by way of example (and not by way of limitation).

In a first such case, it may be that HARQ enablement information of a DCI (e.g., that schedules the TBs) is configured to be applied with respect to both semi-statically enabled HARQ processes and semi-statically disabled HARQ processes. In such a case, various alternatives are possible. In a first alternative, it may be that a single value (e.g., a single bit) in a field of the DCI indicates HARQ enablement statuses for all the TBs (e.g., each such HARQ enablement status will be set in the manner represented by the single value). In a second alternative, it may be that multiple values (e.g., multiple bits) in a field of the DCI each indicate a HARQ enablement status for a corresponding one of the TBs.

In a second such case, it may be that HARQ enablement information of a DCI is configured to be applied with respect to only semi-statically disabled HARQ processes. In such a case, if all the TBs use semi-statically HARQ enabled processes, then they are not overridden by the DCI (they remain HARQ enabled). Further, in the event that one or more of the TBs uses a semi-statically disabled HARQ processes, the HARQ enablement information is applied with respect to these TBs (which may potentially cause one or more of such TBs to in any case use their corresponding semi-statically disabled HARQ process(es)), while TB(s) that use semi-statically HARQ enabled processes are not overridden (remain HARQ enabled).

In a third such case, it may be that HARQ enablement information of a DCI is configured to be applied with respect to only semi-statically enabled HARQ processes.

In such a case, if all the TBs use semi-statically HARQ disabled processes, then they are not overridden by the DCI (they remain HARQ disabled). Further, in the event that one or more of the TBs uses a semi-statically enabled HARQ processes, the HARQ enablement information is applied with respect to these TBs (which may potentially cause one or more of such TBs to in any case not use their corresponding semi-statically enabled HARQ process(es)), while TB(s) that use semi-statically HARQ disabled processes are not overridden (remain HARQ disabled).

### Various Embodiments With Respect to HARQ Enablement Statuses in IoT NTN

For an NB-IoT UE or an eMTC CE Mode B UE, it may be beneficial to configure/indicate an enabling/disabling of HARQ feedback corresponding to DL transmissions. In such cases, several options may be supported. In a first option, HARQ enablement statuses for one or more HARQ processes are determined by a configured per-HARQ process bitmap. In a second option, HARQ enablement statuses for one or more HARQ processes are directly indicated by DCI, without the configuration of a per-HARQ process bitmap. In a third option, HARQ enablement statuses for one or more HARQ processes are by default determined by a configured per-HARQ process bitmap, but can be dynamically overridden by DCI.

In the third case, where a DCI-based HARQ configuration override mechanism is used, it may be an open question whether DCI-based HARQ configuration override mechanism is applied with respect to both semi-statically enabled HARQ processes and semi-statically disabled HARQ processes (referenced as “Alt. 1” hereinafter), whether the DCI-based HARQ configuration override mechanism is applied with respect to only semi-statically disabled HARQ processes (referenced as “Alt. 2” hereinafter), or whether the DCI-based HARQ configuration override mechanism is applied with respect to only semi-statically enabled HARQ processes (referenced as “Alt. 3” hereinafter).

Criteria to select among these alternatives may include DCI overhead, PDCCH monitoring/power consumption, HARQ timer, impact on scheduling flexibility, UE implementation complexity. With respect to the DCI overhead aspect, it may be that for Alt. 1, an additional bit field may be provided in DCI to indicate overridden HARQ processes (or to indicate enabled/disabled HARQ processes in the first instance in the alternative case of a direct indication by DCI). For Alt. 3, a single specific codepoint of an existing DCI field (e.g., a HARQ-ACK resource field) could be used to indicate the disabling of a semi-statically enabled HARQ process. Similarly, in Alt. 2, a few codepoints of an existing DCI field (e.g., a HARQ-ACK resource field), could be used to indicate the enabling of a semi-statically disabled HARQ process. Overall, both Alt. 2 and Alt. 3 may have a DCI overhead advantage.

With respect to scheduling flexibility, it may be that Alt. 1 achieves full scheduling flexibility. Specifically, any HARQ process, no matter how it is semi-statically configured, could be enabled or disabled through the use of Alt. 1. However, the advantage of this approach, as compared with the case of HARQ enablement status directly indicated by DCI without the configuration of per-HARQ process bitmap, is unclear. On the other hand, both Alt. 2 and Alt. 3 are relatively more restricted than Alt. 1 with respect to scheduling flexibility.

With respect to UE implementation complexity, dynamic switching from enabled HARQ feedback to disabled HARQ feedback has a relatively low UE implementation impact. In this case, a UE simply does not transmit HARQ feedback for disabled HARQ processes. However, for dynamic switching from disabled HARQ feedback to enabled HARQ feedback, a UE to dynamically allocate a buffer to store the log likelihood ratio (LLR) information for combining with HARQ retransmissions, which has a relatively higher impact on the UE implementation. Hence, it may be understood that Alt. 3 has a relative UE implementation complexity advantage.

In some cases corresponding to Alt. 2, the use of the DCI-based HARQ configuration override mechanism to enable HARQ feedback on a semi-statically HARQ disabled process may be performed for purposes of outer loop link adaptation. In this application, a UE may not expect data retransmission even in the case that it reports a NACK to a base station, and hence, a dynamic buffer allocation is not applied, resulting in low UE implementation complexity.

To balance considerations among DCI overhead, scheduling flexibility, and UE implementation complexity, it may be beneficial to allow for the selection of any/all of the alternatives (Alt. 1, Alt. 2, Alt. 3) for use at the UE via configuration. For example, instead of using a 1-bit indication that configures between enabling and disabling the use of HARQ enablement information of a DCI/the HARQ configuration override mechanism with respect to all HARQ processes, there may instead be a 2-bit configuration that is used to select among the following options:
1. The use of the DCI-based HARQ configuration override mechanism is disabled.
2. The DCI-based HARQ configuration override mechanism is applied with respect to both semi-statically enabled HARQ and semi-statically disabled HARQ processes.
3. The DCI-based HARQ configuration override mechanism is applied only with respect to semi-statically disabled HARQ processes.
4. The DCI-based HARQ configuration override mechanism is applied only with respect to semi-statically enabled HARQ processes.

Accordingly, in a first proposal for NB-IoT NTN and eMTC NTN for CE Mode B, with respect to the use of a DCI-based HARQ configuration override mechanism, various alternatives may be supported (and may be selected by configuration). In a first alternative, the DCI-based HARQ configuration override mechanism is disabled (not used). In a second alternative, the DCI-based HARQ configuration override mechanism applies with respect to both semi-statically enabled HARQ and semi-statically disabled HARQ processes. In a third alternative, the DCI-based HARQ configuration override mechanism applied with respect to only semi-statically HARQ disabled processes. In a fourth alternative, the DCI-based HARQ configuration override mechanism applied with respect to only semi-statically HARQ enabled processes.

In cases using a DCI-based HARQ configuration override mechanism, the DCI indication of HARQ enablement information may be made in a field that has been added to a DCI for that purpose, or may be made via the reuse/reinterpretation of an existing field in DCI.

In cases where a DCI-based HARQ configuration override mechanism is applied with respect to both semi-statically HARQ enabled and disabled processes, the DCI indication may be made in a field that has been added to the DCI. In a case where the DCI-based HARQ configuration override mechanism applied with respect to only semi-statically HARQ disabled processes, or in a case where the DCI-based HARQ configuration override mechanism applied with respect to only semi-statically HARQ enabled processes, the DCI indication may be made in an existing DCI field that is reused/reinterpreted for such a purpose.

Accordingly, in a second proposal for NB-IoT NTN and eMTC NTN for CE Mode B, with respect to the use of a DCI-based HARQ configuration override mechanism, if a DCI-based HARQ configuration override mechanism is applied with respect to both semi-statically enabled HARQ processes and semi-statically disabled HARQ processes, then the indication is achieved by adding a field to existing DCI. If the DCI-based HARQ configuration override mechanism is instead applied with respect to only semi-statically disabled HARQ processes, or if the DCI-based HARQ configuration override mechanism applied with respect to only semi-statically enabled HARQ processes, the DCI indication may be made in an existing DCI field that is reused/reinterpreted for such a purpose.

For an NB-IoT UE or an eMTC CE Mode B UE that is configured to use a DCI-based HARQ configuration override mechanism, it may be that the mechanism can be applied in the case of multiple TBs scheduled by a single DCI. It may be in such cases that the HARQ enablement information in the DCI applies to all the applicable TBs.

Specifically, if Alt. 2 is configured, then the DCI-based HARQ configuration override mechanism applies with respect to all the TBs scheduled by the DCI. If Alt. 3 is configured, then the DCI-based HARQ configuration override mechanism applies with respect to all the TBs scheduled by the DCI that are associated with semi-statically disabled HARQ processes. If Alt. 4 is configured, then the DCI-based HARQ configuration override mechanism applies with respect to all the TBs scheduled by the DCI that are associated with semi-statically enabled HARQ processes.

Accordingly, in a third proposal for NB-IoT NTN and eMTC NTN for CE Mode B, in the case where a single DCI schedules multiple TBs, a DCI-based HARQ configuration override mechanism is supported and applies to all the applicable TBs (e.g., as just discussed).

For an NB-IoT UE or an eMTC CE Mode B UE that is configured to use a DCI-based HARQ configuration override mechanism, it may be that HARQ enablement information in the DCI is interpreted to potentially reverse the HARQ enablement statuses defined based on a semi-static per-HARQ process configuration, or it may be that HARQ enablement information in the DCI directly indicates the HARQ enablement statuses for affected HARQ processes (regardless of any semi-static per-HARQ process configuration).

In cases where a DCI-based HARQ configuration override mechanism is configured to be applied with respect to both semi-statically HARQ enabled and disabled processes (Alt. 2), then HARQ enablement information in the DCI may directly indicate the HARQ enablement statuses regardless of any semi-static per-HARQ process configuration. This may help achieve the common design for “Option 3” and “Option 3+Option 1” cases as these are discussed herein. If the DCI-based HARQ configuration override mechanism is configured to be applied with respect to only semi-statically disabled HARQ processes, or if the DCI-based HARQ configuration override mechanism applied with respect to only semi-statically enabled HARQ processes, then HARQ enablement information in the DCI may be interpreted as potentially reversing any semi static per-HARQ process configuration for the HARQ processes of the applicable type.

Accordingly, in a fourth proposal for NB-IoT NTN and eMTC NTN for CE Mode B, when using a DCI-based HARQ configuration override mechanism, if the DCI-based HARQ configuration override mechanism is configured to be applied with respect to both semi-statically enabled HARQ processes and semi-statically disabled HARQ processes), then HARQ enablement information in the DCI is understood to directly indicate HARQ enablement statuses (regardless of per-HARQ process configuration). Further, if the DCI-based HARQ configuration override mechanism applied with respect to only semi-statically disabled HARQ processes, or if the DCI-based HARQ configuration override mechanism applied with respect to only semi-statically enabled HARQ processes, then HARQ enablement information in the DCI is interpreted to potentially reverse a semi-static per-HARQ process configuration for each of the HARQ processes of the applicable type.

In IoT, it may be that a single DCI schedules multiple TBs. In some cases, if a subset of these multiple TBs are associated with a HARQ processes that is disabled, then ACK may simply be assumed for those TBs in the feedback. This applies to both the case with HARQ bundling and the case without HARQ bundling, such that a unified design is enabled (and less specification impact is incurred).

Accordingly, in a fifth proposal for both NB-IoT and eMTC NTN, if a single DCI schedules multiple TBs, then ACK is assumed for the DL transmissions using disabled HARQ processes. This applies to both cases with HARQ bundling and cases without HARQ bundling.

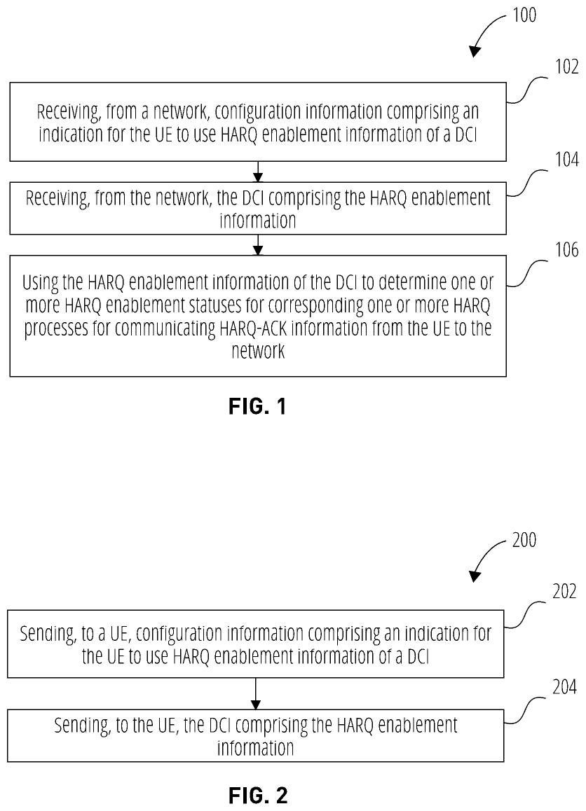

FIG. 1 illustrates a method 100 of a UE, according to embodiments herein. The method 100 includes receiving 102, from a network, configuration information comprising an indication for the UE to use HARQ enablement information of a DCI. The method 100 further includes receiving 104, from the network, the DCI comprising the HARQ enablement information. The method 100 further includes using 106 the HARQ enablement information of the DCI to determine one or more HARQ enablement statuses for corresponding one or more HARQ processes for communicating HARQ-ACK information from the UE to the network.

In some embodiments, the method 100 further includes identifying, based on a value of the indication, one or more semi-statically enabled HARQ processes at the UE and one or more semi-statically disabled HARQ processes at the UE as part of the one or more HARQ processes for which the HARQ enablement information of the DCI is used.

In some embodiments, the method 100 further includes identifying, based on a value of the indication, one or more semi-statically enabled HARQ processes at the UE as part of the one or more HARQ processes for which the HARQ enablement information of the DCI is used.

In some embodiments, the method 100 further includes identifying, based on a value of the indication, one or more semi-statically disabled HARQ processes at the UE as part of the one or more HARQ processes for which the HARQ enablement information of the DCI is used.

In some embodiments of the method 100, the HARQ enablement information is used by the UE to override one or more semi-statically configured HARQ enablement statuses for the one or more HARQ processes.

In some embodiments of the method 100, the HARQ enablement information is used by the UE to reverse one or more semi-statically configured HARQ enablement statuses for the one or more HARQ processes.

FIG. 2 illustrates a method 200 of a RAN, according to embodiments herein.

The method 200 includes sending 202, to a UE, configuration information comprising an indication for the UE to use HARQ enablement information of a DCI. The method 200 further includes sending 204, to the UE, the DCI comprising the HARQ enablement information.

In some embodiments, the method 200 further includes determining, based on the HARQ enablement information, one or more HARQ enablement statuses for corresponding one or more HARQ processes for receiving HARQ-ACK information from the UE.

In some embodiments of the method 200, a value of the indication indicates that one or more semi-statically enabled HARQ processes at the UE and one or more semi-statically disabled HARQ processes at the UE are part of one or more HARQ processes for which corresponding one or more HARQ enablement statuses are determined using the HARQ enablement information of the DCI.

In some embodiments of the method 200, a value of the indication indicates that one or more semi-statically enabled HARQ processes at the UE are part of one or more HARQ processes for which corresponding one or more HARQ enablement statuses are determined using the HARQ enablement information of the DCI.

In some embodiments of the method 200, a value of the indication indicates that one or more semi-statically disabled HARQ processes at the UE are part of one or more HARQ processes for which corresponding one or more HARQ enablement statuses are determined using the HARQ enablement information of the DCI.

In some embodiments of the method 200, the HARQ enablement information is configured to override one or more semi-statically configured HARQ enablement statuses for one or more HARQ processes.

In some embodiments of the method 200, the HARQ enablement information is configured to reverse one or more semi-statically configured HARQ enablement statuses for one or more HARQ processes.

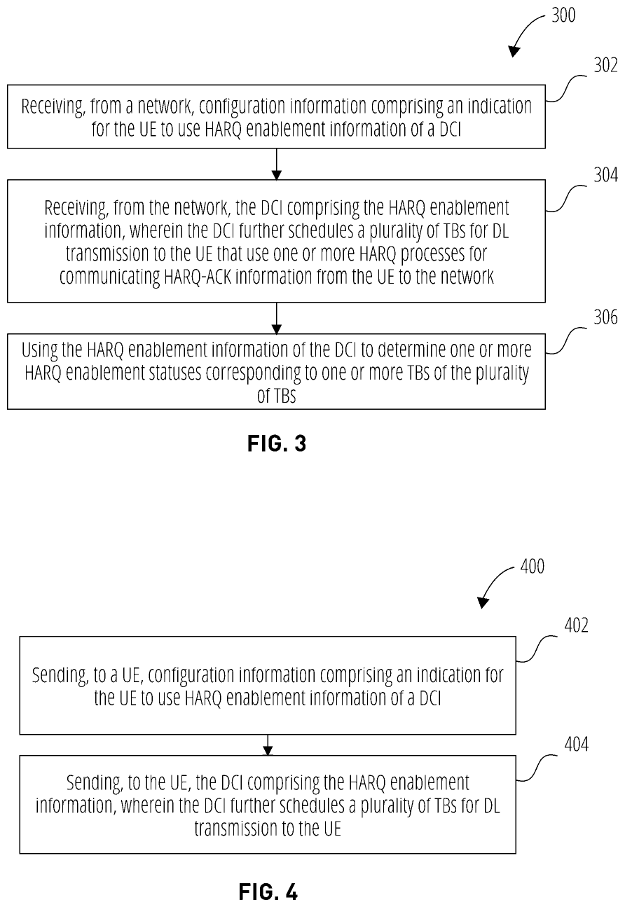

FIG. 3 illustrates a method 300 of a UE, according to embodiments herein. The method 300 includes receiving 302, from a network, configuration information comprising an indication for the UE to use HARQ enablement information of a DCI. The method 300 further includes receiving 304, from the network, the DCI comprising the HARQ enablement information, wherein the DCI further schedules a plurality of TBs for DL transmission to the UE that use one or more HARQ processes for communicating HARQ-ACK information from the UE to the network. The method 300 further using 306 the HARQ enablement information of the DCI to determine one or more HARQ enablement statuses corresponding to one or more TBs of the plurality of TBs.

In some embodiments of the method 300, the HARQ enablement information comprises a single value that indicates the HARQ enablement statuses for each of the one or more TBs.

In some embodiments of the method 300, the HARQ enablement information comprises a plurality of values that each indicate a HARQ enablement status for one of the one or more TBs.

In some embodiments, the method 300 further includes identifying, based on a value of the indication, one or more of the plurality of TBs that uses a semi-statically enabled HARQ process and one or more of the plurality of TBs that uses a semi-statically disabled HARQ process as part of the one or more TBs for which the HARQ enablement information of the DCI is used.

In some embodiments, the method 300 further includes identifying, based on a value of the indication, one or more of the plurality of TBs that uses a semi-statically enabled HARQ process as part of the one or more TBs for which the HARQ enablement information of the DCI is used.

In some embodiments, the method 300 further includes identifying, based on a value of the indication, one or more of the plurality of TBs that uses a semi-statically disabled HARQ process as part of the one or more TBs for which the HARQ enablement information of the DCI is used.

FIG. 4 illustrates a method 400 of a RAN, according to embodiments herein.

The method 400 includes sending 402, to a UE, configuration information comprising an indication for the UE to use HARQ enablement information of a DCI. The method 400 further includes sending 404, to the UE, the DCI comprising the HARQ enablement information, wherein the DCI further schedules a plurality of TBs for DL transmission to the UE.

In some embodiments, the method 400 further includes determining, based on the HARQ enablement information of the DCI, one or more HARQ enablement statuses for corresponding one or more TBs of plurality of TBs for receiving HARQ-ACK information from the UE.

In some embodiments of the method 400, the HARQ enablement information comprises a single value that indicates a HARQ enablement status for one or more of the plurality of TBs.

In some embodiments of the method 400, the HARQ enablement information comprises a plurality of values that each indicate a HARQ enablement status for one of the plurality of TBs.

In some embodiments of the method 400, a value of the indication indicates that one or more of the plurality of TBs that uses a semi-statically enabled HARQ process and one or more of the plurality of TBs that uses a semi-statically disabled HARQ process is part of one or more TBs for which corresponding one or more HARQ enablement statuses are determined using the HARQ enablement information of the DCI.

In some embodiments of the method 400, a value of the indication indicates that one or more of the plurality of TBs that uses a semi-statically enabled HARQ process is part of one or more TBs for which corresponding one or more HARQ enablement statuses are determined using the HARQ enablement information of the DCI.

In some embodiments of the method 400, a value of the indication indicates that one or more of the plurality of TBs that uses a semi-statically disabled HARQ process is part of one or more TBs for which corresponding one or more HARQ enablement statuses are determined using the HARQ enablement information of the DCI.

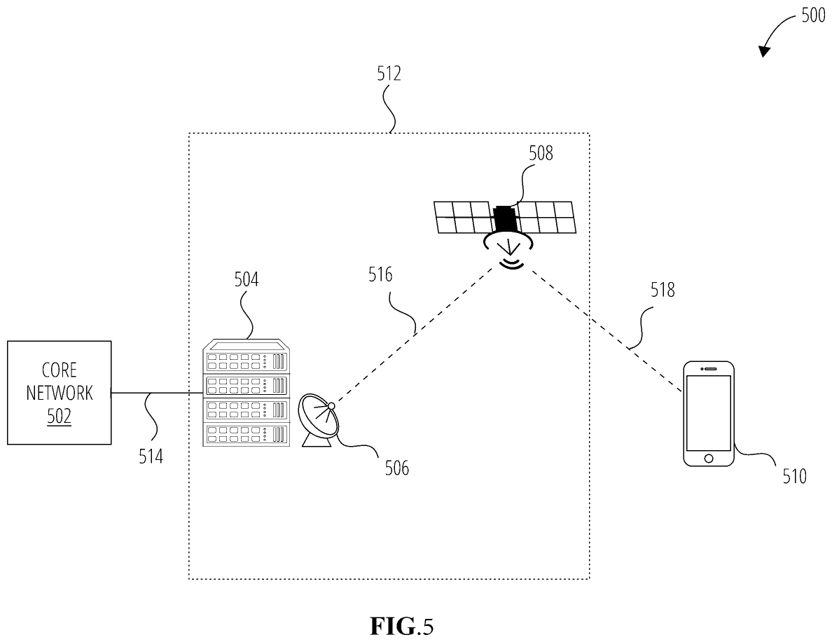

FIG. 5 illustrates an NTN architecture 500 of a wireless communication system, according to an embodiment. The NTN architecture 500 includes a core network (CN) 502, a terrestrial base station 504, a satellite gateway 506, a satellite 508, and a UE 510. The terrestrial base station 504, the satellite gateway 506, and the satellite 508 may be included in a RAN 512.

In some embodiments, the RAN 512 includes E-UTRAN, the CN 502 includes an EPC, and the terrestrial base station 504 includes an eNB. In these cases, the CN link 514 connecting the CN 502 and the terrestrial base station 504 may include an S1 interface.

In some embodiments, RAN 512 includes NG-RAN, the CN 502 includes a 5GC, and the terrestrial base station 504 includes a gNB or a next generation eNB (ng-eNB). In such cases, the CN link 514 connecting the CN 502 and the terrestrial base station 504 may include an NG interface.

The NTN architecture 500 illustrates a “bent-pipe” or “transparent” satellite based architecture. In such bent-pipe systems, the terrestrial base station 504 uses the satellite gateway 506 to communicate with the satellite 508 over a feeder link 516. The satellite 508 may be equipped with one or more antennas capable of broadcasting a cell according to the RAN 512, and the UE 510 may be equipped with one or more antennas (e.g., a moving parabolic antenna, an omni-directional phased-array antenna, etc.) capable of communicating with the satellite 508 via a Uu interface on that cell (such communications may be said to use the illustrated service link 518). A payload sited on the satellite 508 then transparently forwards data between the satellite gateway 506 and the UE 510 using the feeder link 516 between the satellite gateway 506 and the satellite 508 and the service link 518 between the satellite 508 and the UE 510. The payload may perform radio frequency (RF) conversion and/or amplification in both uplink (UL) and downlink (DL) to enable this communication.

In the embodiment shown in FIG. 5, the terrestrial base station 504 is illustrated without the capability of terrestrial wireless communication directly with a UE.

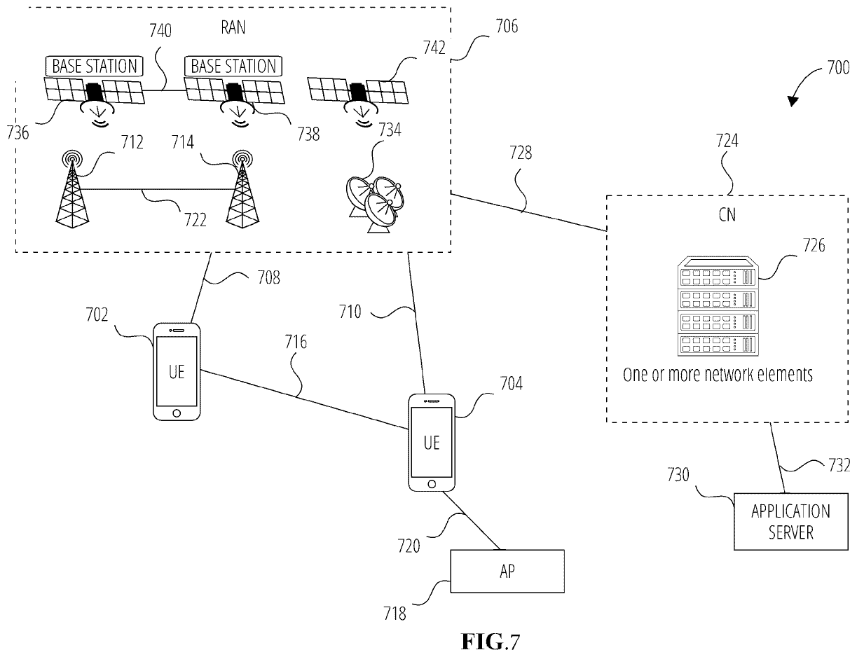

However, it is contemplated that in other embodiments, such a terrestrial base station using the satellite gateway 506 to communicate with the satellite 508 could (also) have this functionality (i.e., as in the terrestrial base station 712 and the terrestrial base station 714 of FIG. 7, to be described below).

It may be understood that, in alternative embodiments to FIG. 5, the satellite 508 may instead be a non-satellite NTN vehicle (e.g., an airplane, an unmanned aerial vehicle (UAV), an unmanned aircraft system (UAS), an airship, a balloon, etc.). Further, it may be understood in such alternative embodiments that the satellite gateway 506 may instead be a gateway for or corresponding to the applicable NTN vehicle type.

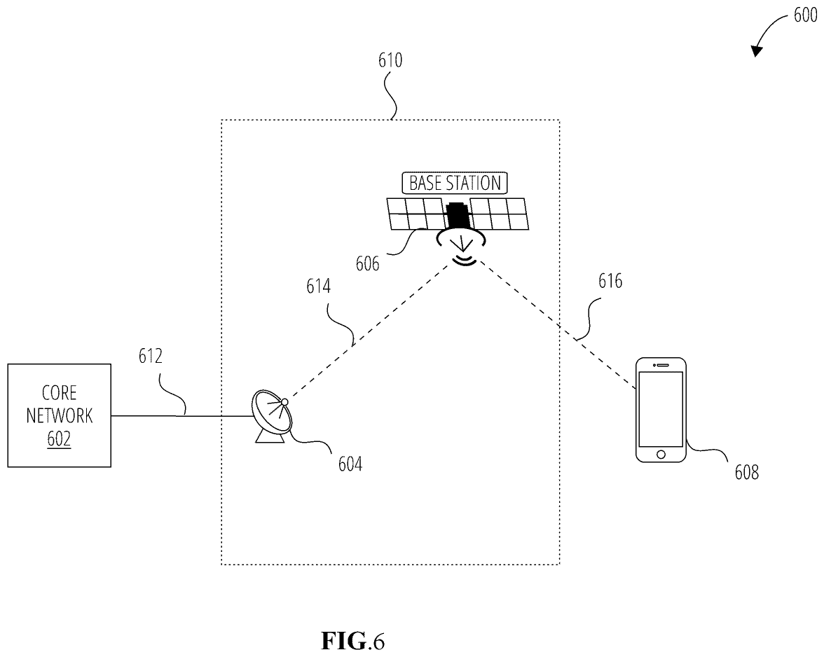

FIG. 6 illustrates an NTN architecture 600 of a wireless communication system, according to an embodiment. The NTN architecture 600 includes a CN 602, a satellite gateway 604, a satellite base station 606, and a UE 608. The satellite gateway 604 and the satellite base station 606 may be included in the RAN 610.

In some embodiments, the RAN 610 includes E-UTRAN and the CN 602 includes an EPC. In these cases, the CN link 612 connecting the CN 602 and the satellite gateway 604 may include an S1 interface.

In some embodiments, RAN 610 includes NG-RAN and the CN 602 includes a 5GC. In such cases, the CN link 612 connecting the CN 602 and the satellite gateway 604 may include an NG interface.

The NTN architecture 500 implements a “regenerative” satellite based architecture. In such regenerative systems, the functionalities of a base station are sited on the satellite base station 606, and the communications between these base station functions and the CN 602 occur through a forwarding of interface(s) (e.g., a S1 interface and/or an NG interface) found on the CN link 612 through the satellite gateway 604 and a feeder link 614 to the satellite base station 606. The satellite base station 606 may be equipped with one or more antennas capable of broadcasting a cell according to the RAN 610, and the UE 608 may be equipped with one or more antennas (e.g., a moving parabolic antenna, an omni-directional phased-array antenna, etc.) capable of communicating with the satellite base station 606 via a Uu interface on that cell (such communications may be said to use the illustrated service link 616). A payload sited on the satellite base station 606 then forwards data between the satellite gateway 604 and the UE 608 using the feeder link 614 between the satellite gateway 604 and the satellite base station 606 and the service link 616 between the satellite base station 606 and the UE 608. The payload may perform RF conversion and/or amplification in both uplink (UL) and downlink (DL) to enable this communication, as well as implement the functionalities of the base station (e.g., as an eNB, ng-eNB or a gNB, as corresponding to the type of the RAN 610) as these have been sited on the satellite base station 606.

In embodiments of NTN architectures comprising NG-RAN that also use integrated access and backhaul (IAB), it is possible that a gNB control unit functionality (CU) could be sited terrestrially and may use a satellite gateway to communicate with a satellite that hosts a corresponding gNB donor unit functionality (DU), with the F1 interface(s) between the CU and the DU underpinned by the feeder link 614. In such cases, the CU and the DU may each be understood to be part of the NG-RAN.

It may be understood that, in alternative embodiments to FIG. 6, the satellite base station 606 may instead be a non-satellite NTN base station (e.g., an airplane, a UAV, a UAS, an airship, a balloon, etc.). Further, it may be understood in such alternative embodiments that the satellite gateway 604 may instead be a gateway for or corresponding to the applicable NTN vehicle type.

FIG. 7 illustrates an example architecture of a wireless communication system 700, according to embodiments disclosed herein. The following description is provided for an example wireless communication system 700 that operates in conjunction with the LTE system standards and/or 5G or NR system standards as provided by 3GPP technical specifications and other 3GPP documents.

As shown by FIG. 7, the wireless communication system 700 includes UE 702 and UE 704 (although any number of UEs may be used). In this example, the UE 702 and the UE 704 are illustrated as smartphones (e.g., handheld touchscreen mobile computing devices connectable to one or more cellular networks), but may also comprise any mobile or non-mobile computing device configured for wireless communication.

The UE 702 and UE 704 may be configured to communicatively couple with a RAN 706. In embodiments, the RAN 706 may be NG-RAN, E-UTRAN, etc. The UE 702 and UE 704 utilize connections (or channels) (shown as connection 708 and connection 710, respectively) with the RAN 706, each of which comprises a physical communications interface. The RAN 706 can include one or more base stations (such as terrestrial base station 712, the terrestrial base station 714 the satellite base station 736 and the satellite base station 738) and/or other entities (e.g., the satellite 742, which may not have base station functionality) that enable the connection 708 and connection 710. One or more satellite gateways 734 may integrate the satellite base station 736, satellite base station 738, and/or the satellite 742 into the RAN 706, in the manners (and with the appropriate elements) described in relation to the NTN architecture 500 of FIG. 5 and the NTN architecture 600 of FIG. 6.

It may be understood that, in alternative embodiments to FIG. 7, the satellite base station 736, the satellite base station 738, and/or the satellite 742 may instead comprise a non-satellite NTN vehicle (e.g., an airplane, a UAV, a UAS, an airship, a balloon, etc.). Further, it may be understood in such alternative embodiments that any satellite gateway 734 may be a gateway for or corresponding to that applicable NTN vehicle type.

In this example, the connection 708 and connection 710 are air interfaces to enable such communicative coupling, and may be consistent with RAT(s) used by the RAN 706, such as, for example, an LTE and/or NR. It is contemplated that the connection 708 and connection 710 may include, in some embodiments, service links between their respective UE 702, UE 704 and one or more of the satellite base station 736, the satellite base station 738, and the satellite 742.

In some embodiments, the UE 702 and UE 704 may also directly exchange communication data via a sidelink interface 716.

The UE 704 is shown to be configured to access an access point (shown as AP 718) via connection 720. By way of example, the connection 720 can comprise a local wireless connection, such as a connection consistent with any IEEE 802.11 protocol, wherein the AP 718 may comprise a Wi-Fi® router. In this example, the AP 718 may be connected to another network (for example, the Internet) without going through a CN 724.

In embodiments, the UE 702 and UE 704 can be configured to communicate using orthogonal frequency division multiplexing (OFDM) communication signals with each other, with the terrestrial base station 712, the terrestrial base station 714, the satellite base station 736, the satellite base station 738, and/or the satellite 742 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the terrestrial base station 712, terrestrial base station 714, the satellite base station 736 and/or the satellite base station 738 may be implemented as one or more software entities running on server computers as part of a virtual network.

In addition, or in other embodiments, the terrestrial base station 712 or terrestrial base station 714 may be configured to communicate with one another via interface 722. In embodiments where the wireless communication system 700 is an LTE system (e.g., when the CN 724 is an EPC), the interface 722 may be an X2 interface. The X2 interface may be defined between two or more base stations (e.g., two or more eNBs and the like) that connect to an EPC, and/or between two eNBs connecting to the EPC. It is contemplated than an inter-satellite link (ISL) may carry the X2 interface between in the case of two satellite base stations.

In embodiments where the wireless communication system 700 is an NR system (e.g., when CN 724 is a 5GC), the interface 722 may be an Xn interface. An Xn interface is defined between two or more base stations that connect to 5GC (e.g., CN 724). For example, the Xn interface may be between two or more gNBs that connect to 5GC, a gNB connecting to 5GC and an eNB, between two eNBs connecting to 5GC, and/or two or more satellite base stations via an ISL (as in, e.g., the interface 740 between the satellite base station 736 and the satellite base station 738).

The RAN 706 is shown to be communicatively coupled to the CN 724. The CN 724 may comprise one or more network elements 726, which are configured to offer various data and telecommunications services to customers/subscribers (e.g., users of UE 702 and UE 704) who are connected to the CN 724 via the RAN 706. The components of the CN 724 may be implemented in one physical device or separate physical devices including components to read and execute instructions from a machine-readable or computer-readable medium (e.g., a non-transitory machine-readable storage medium).

For example, the components of the CN 724 may be implemented in one or more processors and/or one or more associated memories.

In embodiments, the CN 724 may be an EPC, and the RAN 706 may be connected with the CN 724 via an S1 interface 728. In embodiments, the S1 interface 728 may be split into two parts, an S1 user plane (S1-U) interface, which carries traffic data between the terrestrial base station 712, terrestrial base station 714, the satellite base station 736, or the interface 740 and a serving gateway (S-GW), and the S1-MME interface, which is a signaling interface between the terrestrial base station 712, the terrestrial base station 714 the satellite base station 736, or the interface 740 and mobility management entities (MMEs).

In embodiments, the CN 724 may be a 5GC, and the RAN 706 may be connected with the CN 724 via an NG interface 728. In embodiments, the NG interface 728 may be split into two parts, an NG user plane (NG-U) interface, which carries traffic data between the terrestrial base station 712, terrestrial base station 714, satellite base station 736, or satellite base station 738 and a user plane function (UPF), and the S1 control plane (NG-C) interface, which is a signaling interface between the terrestrial base station 712, terrestrial base station 714 satellite base station 736, or satellite base station 738 and access and mobility management functions (AMFs).

Generally, an application server 730 may be an element offering applications that use internet protocol (IP) bearer resources with the CN 724 (e.g., packet switched data services). The application server 730 can also be configured to support one or more communication services (e.g., VoIP sessions, group communication sessions, etc.) for the UE 702 and UE 704 via the CN 724. The application server 730 may communicate with the CN 724 through an IP communications interface 732.

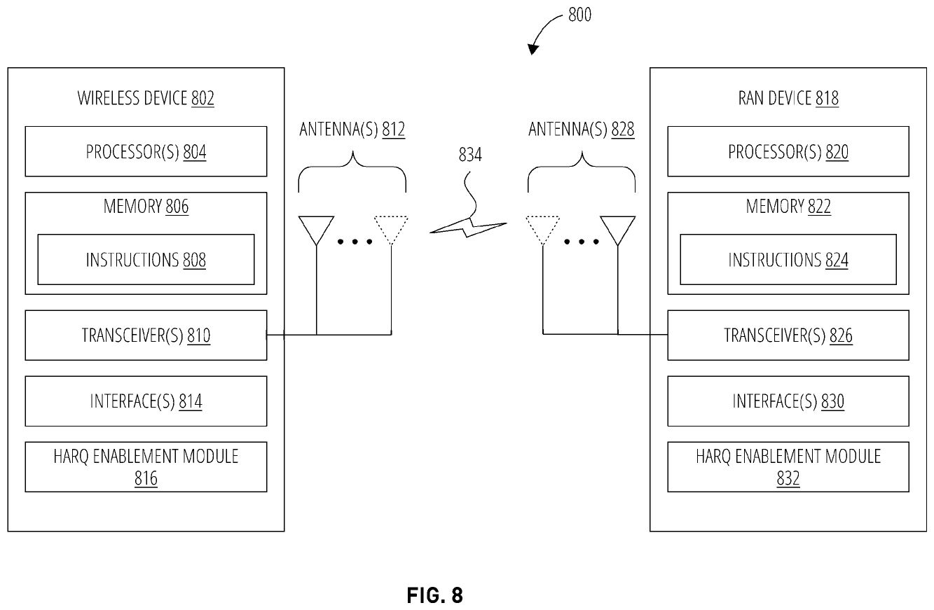

FIG. 8 illustrates a system 800 for performing signaling 834 between a wireless device 802 and a RAN device 818, according to embodiments disclosed herein. The system 800 may be a portion of a wireless communications system as herein described.

The wireless device 802 may be, for example, a UE of a wireless communication system. The RAN device 818 may be, for example, a base station (e.g., an eNB or a gNB) of a wireless communication system that is a terrestrial base station or that is a non-terrestrial base station sited on an NTN vehicle. In the case of a RAN device 818 that is a terrestrial base station, the RAN device 818 may be in communication with an NTN vehicle that directly provides radio access connectivity to a UE, in the manner described herein.

The wireless device 802 may include one or more processor(s) 804. The processor(s) 804 may execute instructions such that various operations of the wireless device 802 are performed, as described herein. The processor(s) 804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 802 may include a memory 806. The memory 806 may be a non-transitory computer-readable storage medium that stores instructions 808 (which may include, for example, the instructions being executed by the processor(s) 804). The instructions 808 may also be referred to as program code or a computer program. The memory 806 may also store data used by, and results computed by, the processor(s) 804.

The wireless device 802 may include one or more transceiver(s) 810 that may include RF transmitter and/or receiver circuitry that use the antenna(s) 812 of the wireless device 802 to facilitate signaling (e.g., the signaling 834) to and/or from the wireless device 802 with other devices (e.g., the RAN device 818) according to corresponding RATs. In some embodiments, the antenna(s) 812 may include a moving parabolic antenna, an omni-directional phased-array antenna, or some other antenna suitable for communication with an NTN vehicle, (e.g., as described above in relation to the UE 510 of FIG. 5 and the UE 608 of FIG. 6).

For a RAN device 818 that is a terrestrial base station, the network device signaling 834 may occur on a service link between the wireless device 802 and an NTN vehicle and a feeder link between the NTN vehicle and the RAN device 818 (e.g., as described in relation to FIG. 5). For a RAN device 818 that is a base station sited on an NTN vehicle, the signaling 834 may occur on a service link between the wireless device 802 and the RAN device 818 (e.g., as described in relation to FIG. 6).

The wireless device 802 may include one or more antenna(s) 812 (e.g., one, two, four, or more). For embodiments with multiple antenna(s) 812, the wireless device 802 may leverage the spatial diversity of such multiple antenna(s) 812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 802 may be accomplished according to precoding (or digital beamforming) that is applied at the wireless device 802 that multiplexes the data streams across the antenna(s) 812 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 802 may implement analog beamforming techniques, whereby phases of the signals sent by the antenna(s) 812 are relatively adjusted such that the (joint) transmission of the antenna(s) 812 can be directed (this is sometimes referred to as beam steering).

The wireless device 802 may include one or more interface(s) 814. The interface(s) 814 may be used to provide input to or output from the wireless device 802. For example, a wireless device 802 that is a UE may include interface(s) 814 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 810/antenna(s) 812 already described) that allow for communication between the UE and other devices and may operate according to known protocols (e.g., Wi-Fi®, Bluetooth®, and the like).

The wireless device 802 may include a HARQ enablement module 816. The HARQ enablement module 816 may be implemented via hardware, software, or combinations thereof. For example, the HARQ enablement module 816 may be implemented as a processor, circuit, and/or instructions 808 stored in the memory 806 and executed by the processor(s) 804. In some examples, the HARQ enablement module 816 may be integrated within the processor(s) 804 and/or the transceiver(s) 810. For example, the HARQ enablement module 816 may be implemented by a combination of software components (e.g., executed by a DSP or a general processor) and hardware components (e.g., logic gates and circuitry) within the processor(s) 804 or the transceiver(s) 810.

The HARQ enablement module 816 may be used for various aspects of the present disclosure, for example, aspects of FIG. 1 through FIG. 6. The HARQ enablement module 816 may be configured to, for example, receive configuration information comprising an indication for the UE to use HARQ enablement information of a DCI, receive the DCI comprising the HARQ enablement information, and use the HARQ enablement information of the DCI to determine one or more HARQ enablement statuses for corresponding one or more HARQ processes for communicating HARQ-ACK information from the UE to the network or for one or more TBs using to such HARQ processes, in the manners that are described herein.

The RAN device 818 may include one or more processor(s) 820. The processor(s) 820 may execute instructions such that various operations of the RAN device 818 are performed, as described herein. The processor(s) 804 may include one or more baseband processors implemented using, for example, a CPU, a DSP, an ASIC, a controller, an FPGA device, another hardware device, a firmware device, or any combination thereof configured to perform the operations described herein.

The RAN device 818 may include a memory 822. The memory 822 may be a non-transitory computer-readable storage medium that stores instructions 824 (which may include, for example, the instructions being executed by the processor(s) 820). The instructions 824 may also be referred to as program code or a computer program. The memory 822 may also store data used by, and results computed by, the processor(s) 820.

The RAN device 818 may include one or more transceiver(s) 826 that may include RF transmitter and/or receiver circuitry that use the antenna(s) 828 of the RAN device 818 to facilitate signaling (e.g., the signaling 834) to and/or from the RAN device 818 with other devices (e.g., the wireless device 802) according to corresponding RATs.

The RAN device 818 may include one or more antenna(s) 828 (e.g., one, two, four, or more). In embodiments having multiple antenna(s) 828, the RAN device 818 may perform MIMO, digital beamforming, analog beamforming, beam steering, etc., as has been described.

For a RAN device 818 that is a terrestrial base station, one or more of the transceiver(s) 826 and/or the antenna(s) 828 may instead be present on a satellite gateway (or a gateway for another applicable NTN vehicle type) associated with the base station (e.g., as shown in reference to the terrestrial base station 504 and the satellite gateway 506 of FIG. 5). For a RAN device 818 that is a base station sited on an NTN vehicle, the transceiver(s) 826 and/or the antenna(s) 828 may be present on the NTN vehicle, and one or more of those antenna(s) 828 may be antenna(s) appropriate for non-terrestrial communication (such as a moving parabolic antenna, an omni-directional phased-array antenna, etc.) The RAN device 818 may include one or more interface(s) 830. The interface(s) 830 may be used to provide input to or output from the RAN device 818. For example, a RAN device 818 that is a base station may include interface(s) 830 made up of transmitters, receivers, and other circuitry (e.g., other than the transceiver(s) 826/antenna(s) 828 already described) that enables the base station to communicate with other equipment in a CN, and/or that enables the base station to communicate with external networks, computers, databases, and the like for purposes of operations, administration, and maintenance of the base station or other equipment operably connected thereto.

The RAN device 818 may include a HARQ enablement module 832. The HARQ enablement module 832 may be implemented via hardware, software, or combinations thereof. For example, the HARQ enablement module 832 may be implemented as a processor, circuit, and/or instructions 824 stored in the memory 822 and executed by the processor(s) 820. In some examples, the HARQ enablement module 832 may be integrated within the processor(s) 820 and/or the transceiver(s) 826. For example, the HARQ enablement module 832 may be implemented by a combination of software components (e.g., executed by a DSP or a general processor) and hardware components (e.g., logic gates and circuitry) within the processor(s) 820 or the transceiver(s) 826.

The HARQ enablement module 832 may be used for various aspects of the present disclosure, for example, aspects of FIG. 1 through FIG. 6. The HARQ enablement module 832 may be configured to, for example, send configuration information comprising an indication for the UE to use HARQ enablement information of a DCI and to send the DCI comprising the HARQ enablement information, in the manners that are described herein.

Embodiments contemplated herein include an apparatus comprising means to perform one or more elements of any of the method 100 and the method 300. This apparatus may be, for example, an apparatus of a UE (such as a wireless device 802 that is a UE, as described herein).

Embodiments contemplated herein include one or more non-transitory computer-readable media comprising instructions to cause an electronic device, upon execution of the instructions by one or more processors of the electronic device, to perform one or more elements of any of the method 100 and the method 300. This non-transitory computer-readable media may be, for example, a memory of a UE (such as a memory 806 of a wireless device 802 that is a UE, as described herein).

Embodiments contemplated herein include an apparatus comprising logic, modules, or circuitry to perform one or more elements of any of the method 100 and the method 300. This apparatus may be, for example, an apparatus of a UE (such as a wireless device 802 that is a UE, as described herein).

Embodiments contemplated herein include an apparatus comprising: one or more processors and one or more computer-readable media comprising instructions that, when executed by the one or more processors, cause the one or more processors to perform one or more elements of any of the method 100 and the method 300. This apparatus may be, for example, an apparatus of a UE (such as a wireless device 802 that is a UE, as described herein).

Embodiments contemplated herein include a signal as described in or related to one or more elements of any of the method 100 and the method 300.

Embodiments contemplated herein include a computer program or computer program product comprising instructions, wherein execution of the program by a processor is to cause the processor to carry out one or more elements of any of the method 100 and the method 300. The processor may be a processor of a UE (such as a processor(s) 804 of a wireless device 802 that is a UE, as described herein). These instructions may be, for example, located in the processor and/or on a memory of the UE (such as a memory 806 of a wireless device 802 that is a UE, as described herein).

Embodiments contemplated herein include an apparatus comprising means to perform one or more elements of any of the method 200 and the method 400. This apparatus may be, for example, an apparatus of a base station (such as a RAN device 818 that is a base station, as described herein).

Embodiments contemplated herein include one or more non-transitory computer-readable media comprising instructions to cause an electronic device, upon execution of the instructions by one or more processors of the electronic device, to perform one or more elements of any of the method 200 and the method 400. This non-transitory computer-readable media may be, for example, a memory of a base station (such as a memory 822 of a RAN device 818 that is a base station, as described herein).

Embodiments contemplated herein include an apparatus comprising logic, modules, or circuitry to perform one or more elements of any of the method 200 and the method 400. This apparatus may be, for example, an apparatus of a base station (such as a RAN device 818 that is a base station, as described herein).

Embodiments contemplated herein include an apparatus comprising: one or more processors and one or more computer-readable media comprising instructions that, when executed by the one or more processors, cause the one or more processors to perform one or more elements of any of the method 200 and the method 400. This apparatus may be, for example, an apparatus of a base station (such as a RAN device 818 that is a base station, as described herein).

Embodiments contemplated herein include a signal as described in or related to one or more elements of any of the method 200 and the method 400.

Embodiments contemplated herein include a computer program or computer program product comprising instructions, wherein execution of the program by a processing element is to cause the processing element to carry out one or more elements of any of the method 200 and the method 400. The processor may be a processor of a base station (such as processor(s) 820 of a RAN device 818 that is a base station, as described herein). These instructions may be, for example, located in the processor and/or on a memory of the base station (such as a memory 822 of a RAN device 818that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
receiving, from a network, configuration information comprising an indication for the UE to use hybrid automatic repeat request (HARQ) enablement information of a downlink control information (DCI);
receiving, from the network, the DCI comprising the HARQ enablement information; and
using the HARQ enablement information of the DCI to determine one or more HARQ enablement statuses for corresponding one or more HARQ processes for communicating HARQ acknowledgement (HARQ-ACK) information from the UE to the network.

2. The method of claim 1, further comprising identifying, based on a value of the indication, one or more semi-statically enabled HARQ processes at the UE and one or more semi-statically disabled HARQ processes at the UE as part of the one or more HARQ processes for which the HARQ enablement information of the DCI is used.

3. The method of claim 1, further comprising identifying, based on a value of the indication, one or more semi-statically enabled HARQ processes at the UE as part of the one or more HARQ processes for which the HARQ enablement information of the DCI is used.

4. The method of claim 1, further comprising identifying, based on a value of the indication, one or more semi-statically disabled HARQ processes at the UE as part of the one or more HARQ processes for which the HARQ enablement information of the DCI is used.

5. The method of claim 1, wherein the HARQ enablement information is used by the UE to override one or more semi-statically configured HARQ enablement statuses for the one or more HARQ processes.

6. The method of claim 1, wherein the HARQ enablement information is used by the UE to reverse one or more semi-statically configured HARQ enablement statuses for the one or more HARQ processes.

7. A method of a radio access network (RAN), comprising:
sending, to a user equipment (UE), configuration information comprising an indication for the UE to use hybrid automatic repeat request (HARQ) enablement information of a downlink control information (DCI); and
sending, to the UE, the DCI comprising the HARQ enablement information.

8. The method of claim 7, further comprising determining, based on the HARQ enablement information, one or more HARQ enablement statuses for corresponding one or more HARQ processes for receiving HARQ acknowledgement (HARQ-ACK) information from the UE.

9. The method of claim 7, wherein a value of the indication indicates that one or more semi-statically enabled HARQ processes at the UE and one or more semi-statically disabled HARQ processes at the UE are part of one or more HARQ processes for which corresponding one or more HARQ enablement statuses are determined using the HARQ enablement information of the DCI.

10. The method of claim 7, wherein a value of the indication indicates that one or more semi-statically enabled HARQ processes at the UE are part of one or more HARQ processes for which corresponding one or more HARQ enablement statuses are determined using the HARQ enablement information of the DCI.

11. The method of claim 7, wherein a value of the indication indicates that one or more semi-statically disabled HARQ processes at the UE are part of one or more HARQ processes for which corresponding one or more HARQ enablement statuses are determined using the HARQ enablement information of the DCI.

12. The method of claim 7, wherein the HARQ enablement information is configured to override one or more semi-statically configured HARQ enablement statuses for one or more HARQ processes.

13. The method of claim 7, wherein the HARQ enablement information is configured to reverse one or more semi-statically configured HARQ enablement statuses for one or more HARQ processes.

14. A method of a user equipment (UE), comprising:
receiving, from a network, configuration information comprising an indication for the UE to use hybrid automatic repeat request (HARQ) enablement information of a downlink control information (DCI);
receiving, from the network, the DCI comprising the HARQ enablement information, wherein the DCI further schedules a plurality of transport blocks (TBs) for downlink (DL) transmission to the UE that use one or more HARQ processes for communicating HARQ acknowledgement (HARQ-ACK) information from the UE to the network; and
using the HARQ enablement information of the DCI to determine one or more HARQ enablement statuses corresponding to one or more TBs of the plurality of TBs.

15. The method of claim 14, wherein the HARQ enablement information comprises a single value that indicates the HARQ enablement statuses for each of the one or more TBs.

16. The method of claim 14, wherein the HARQ enablement information comprises a plurality of values that each indicate a HARQ enablement status for one of the one or more TBs.

17. The method of claim 14, further comprising identifying, based on a value of the indication, one or more of the plurality of TBs that uses a semi-statically enabled HARQ process and one or more of the plurality of TBs that uses a semi-statically disabled HARQ process as part of the one or more TBs for which the HARQ enablement information of the DCI is used.

18. The method of claim 14, further comprising identifying, based on a value of the indication, one or more of the plurality of TBs that uses a semi-statically enabled HARQ process as part of the one or more TBs for which the HARQ enablement information of the DCI is used.

19. The method of claim 14, further comprising identifying, based on a value of the indication, one or more of the plurality of TBs that uses a semi-statically disabled HARQ process as part of the one or more TBs for which the HARQ enablement information of the DCI is used.

20-29. (canceled)
